(19) United States
(12) Patent Application Publication
(10) Pub. No.: US 2020/0180991 A1
(43) Pub. Date: Jun. 11, 2020

(54) GLASS STRUCTURE, GLASS STRUCTURE FORMING SYSTEM, AND METHOD OF MAKING GLASS STRUCTURE

(71) Applicant: CORNING INCORPORATED, CORNING, NY (US)

(72) Inventors: Heather Debra Boek, Corning, NY (US); Thierry Luc Alain Dannoux, Avon (FR)

(21) Appl. No.: 16/608,553

(22) PCT Filed: Apr. 27, 2018
(86) PCT No.: PCT/US2018/029726

§ 371 Date: Oct. 25, 2019

Related U.S. Application Data
(60) Provisional application No. 62/491,582, filed on Apr. 28, 2017.

(51) Int. Cl. C03B 23/035; B01L 3/00

(52) U.S. Cl. CPC C03B 23/0357; B01L 3/5085; C03C 2204/08; B01L 2300/12; B01L 2300/0829

(57) ABSTRACT

A multi-well glass-containing structure, and system and method to manufacture the structure are provided. The structure can be a glass plate having a well defined by a rim at a top of the plate to define a well opening, a well bottom at a bottom of the plate spaced away from the rim by a well wall extending from the rim to the well bottom. A well aspect ratio of the depth of the well to a maximum surface dimension of the well opening can be in a range from 40% to 100%. The inner surface of the well can have an average roughness, Ra, of less than 600 nm. The system can include a mold with a coefficient of thermal expansion that matches the glass-containing structure and the method can include forming the glass plate at a viscosity of about 10⁵ to 10^{7,6} poises.

### CROSS-REFERENCE TO RELATED APPLICATIONS

This application claims the benefit of priority of U.S. Provisional Application Ser. No. 62/491,582 filed on Apr. 28, 2017 the contents of which are relied upon and incorporated herein by reference in their entirety as if fully set forth below.

### BACKGROUND

### Field

Exemplary embodiments of the present disclosure relate to a glass structure, a glass structure forming system, and a method of making a glass structure. More particularly, exemplary embodiments of the present disclosure relate to glass multi-well structures having high well depth to well opening ratio and low average surface roughness, glass multi-well structure forming systems comprising molds of predetermined coefficient of thermal expansion and methods of manufacturing glass multi-well structures having high well depth to well opening ratio and low average surface roughness.

### Discussion of the Background

There can be numerous applications for glass elements comprising wells in a solid piece of glass. These may include everything from multi-well plates to contain biological samples to plates containing thermal or air-sensitive materials such as quantum dots, Organic Light Emitting Diodes (OLEDs), photovoltaics, and refractive index liquids for liquid lenses. Glass can be a desirable material for these applications because of properties such as transparency, inertness toward various organic materials, good durability, resistance to dimensional distortion, resistance to radiation damage, and broad useful temperature range.

There are a variety of ways in which glass can be formed into multi-well structures. These include conventional hot gob pressing, reactive ion etching, chemical etching, photosensitive glass etching, and high viscosity repressing; each may have advantages and disadvantages. For example, hot gob pressing may have a low glass cost relative to the other processes, but result in surface roughness and limited dimensional precision; reactive ion etching may have high dimensional precision, but generally a high cost relative to the other processes; chemical etching may have a lower cost than reactive ion etching, but at still a high cost, and may result in irregular surfaces and roughness; photosensitive glass etching may also be a high cost process, but can result in high dimensional precision and thin features; high viscosity repressing can result in high dimensional precision and medium cost.

Arrays of shallow wells can be made by reforming a glass sheet as disclosed in U.S. patent application Ser. No. 15/000,737, filed Jan. 19, 2016, by Dannoux, et al., the entire contents of which is hereby incorporated by reference as though fully set forth herein. While Dannoux et al. may disclose that well arrays can be produced, how to make deep wells, such as several millimeters up to 10 mm or even deeper by reforming the entire sheet into a corrugated structure is not disclosed.

The above information disclosed in this Background section is only for enhancement of understanding of the background of the disclosure and therefore it may contain information that does not form any part of the prior art nor what the prior art may suggest to a person of ordinary skill in the art.

### SUMMARY

Exemplary embodiments of the present disclosure provide a multi-well glass-containing structure.

Exemplary embodiments of the present disclosure also provide a system to form a multi-well glass-containing structure.

Exemplary embodiments of the present disclosure also provide a method of manufacturing a multi-well structure.

Additional features of the disclosure will be set forth in the description which follows, and in part will be apparent from the description, or may be learned by practice of the disclosure.

An exemplary embodiment discloses a multi-well glass-containing structure including at least one well. The at least one well is defined by a top rim, at least one wall, and a well bottom, wherein the top rim is at a top of a plate to define a well opening, the well bottom is at a bottom of the plate, and the at least one wall extends from the top rim to the well bottom. A well aspect ratio, AR, of the depth of the at least one well, d_{w}, to a maximum surface dimension of the well opening, Dₘₐₓ, AR=d_{w}/Dₘₐₓ×100%, is in a range from 40% to 100% and an inner surface of the at least one well has an average roughness measured by profilometer ZYGO™ New View 7300™ instrument, Ra, of Ra<600 nm.

Another exemplary embodiment discloses a system to manufacture a glass-containing multi-well structure. The system includes a mold, a furnace, and a pressing element. The mold has at least one surface cavity and a coefficient of thermal expansion that substantially matches a coefficient of thermal expansion of a glass-containing sheet to be disposed on a surface comprising the surface cavity. The furnace is configured to heat the mold having the glass-containing sheet disposed thereon to a forming temperature corresponding to a viscosity of about 10⁵ poises to about 10^{7,6} poises of the glass-containing sheet. The pressing element is configured to press the glass-containing sheet at the forming temperature to conform to the at least one surface cavity. The at least one surface cavity is configured to form the glass-containing sheet into at least one well, the at least one well having a well aspect ratio, AR of the depth of the at least one well, d_{w}, to a maximum surface dimension of an open area of the at least one well Dₘₐₓ, AR=d_{w}/Dₘₐₓ×100% in a range from 40% to 100%, and an inner surface of the at least one well having an average roughness measured by profilometer ZYGO™ New View 7300™ instrument, Ra, of Ra<600 nm.

Another exemplary embodiment discloses a method of manufacturing a multi-well structure. The method includes disposing a sheet comprised substantially of glass on a mold having at least one surface cavity, wherein the mold has a first coefficient of thermal expansion and the sheet has a second coefficient of thermal expansion substantially the same as the first coefficient of thermal expansion. The method includes heating isothermally the mold and the sheet to a predetermined temperature, wherein the predetermined temperature corresponds to a viscosity of about 10⁵ poises to about 10^{7,6} poises of the sheet. The method includes applying molding pressure to the sheet to force the sheet to conform to the at least one surface cavity, holding the sheet disposed on the mold under the applied pressure for about 10 to 60 minutes, cooling the sheet disposed on the mold, and removing the sheet from the mold, wherein the sheet comprises at least one well corresponding to the at least one surface cavity. The well has a well aspect ratio, AR of the depth of the at least one well, d_{w}, to a maximum surface dimension of an open area of the at least one well Dₘₐₓ, AR=d_{w}/Dₘₐₓ×100% is in a range from 40% to 100%, and the inner surface of the at least one well has an average roughness measured by profilometer ZYGO™ New View 7300™ instrument, Ra, of Ra<600 nm.

It is to be understood that both the foregoing general description and the following detailed description are exemplary and explanatory and are intended to provide further explanation of the disclosure.

### BRIEF DESCRIPTION OF THE DRAWINGS

The accompanying drawings, which are included to provide a further understanding of the disclosure and are incorporated in and constitute a part of this specification, illustrate exemplary embodiments of the disclosure, and together with the description serve to explain the principles of the disclosure.

FIG. 1 is a bottom perspective view of a repressed multi-well glass plate made according to methods disclosed herein according to an exemplary embodiment of the disclosure.

FIG. 2 is a schematic cutaway diagram of a repressed multi-well plate according to an exemplary embodiment of the disclosure.

FIG. 3A is a cross-sectional view of an exemplary embodiment of a laminated glass article. FIG. 3B is a cross-sectional view of an exemplary embodiment of an overflow distributor that can be used to form a glass article such as, for example, the glass article of FIG. 3A.

FIG. 4A is a schematic side-view diagram of a hermetically sealed glass well having electronic leads extending into the well according to an exemplary embodiment of the disclosure. FIG. 4B is a schematic top-view diagram of the hermetically sealed glass well of FIG. 4A.

FIG. 5 is a schematic diagram of a mold having top and bottom components and two pins according to an exemplary embodiment of the disclosure.

FIG. 6A is a schematic cross-section of a system including the bottom mold component of FIG. 5 having a glass sheet disposed on a mold surface and the top mold component positioned to press the glass sheet into a cavity on the bottom mold component according to an exemplary embodiment of the disclosure. FIG. 6B is a schematic cross-section showing the system of FIG. 6A after heating and pressing according to an exemplary embodiment of the disclosure.

FIG. 7A is a schematic cross-section of a system including a bottom mold component having mold vacuum channels in cavities and having a glass sheet disposed on a mold surface according to an exemplary embodiment of the disclosure. FIG. 7B is a schematic cross-section showing the system of FIG. 7A after heating and pressing by drawing a vacuum under the glass sheet between a bottom surface of the glass sheet and the mold cavities according to an exemplary embodiment of the disclosure.

FIG. 8 is a top perspective view of a repressed multi-well plate made according to methods disclosed herein according to an exemplary embodiment of the disclosure.

FIG. 9 is a bottom perspective view of the repressed multi-well plate of FIG. 8.

FIG. 10A is a schematic partial top-view diagram of a well plate according to an exemplary embodiment of the disclosure. FIG. 10B is a schematic partial side-view diagram of the well plate of FIG. 10A.

### DETAILED DESCRIPTION OF THE ILLUSTRATED EMBODIMENTS

The disclosure is described more fully hereinafter with reference to the accompanying drawings, in which embodiments of the disclosure are shown. This disclosure may, however, be embodied in many different forms and should not be construed as limited to the embodiments set forth herein. Rather, these embodiments are provided so that this disclosure is thorough, and will fully convey the scope of the disclosure to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Wells encapsulated with an air impermeable seal, such as a hermetic seal, may be desired for long-lived applications such as, but not limited to, displays, lighting, and photovoltaics. Glass that provides surface for sealing processes such as laser welding, o-ring, and frit sealing can be particularly advantageous in this regard. For example, laser welding may require two flat, smooth surfaces to create a near optical contact. Even more attractive may be the ability to provide hermetic seals over electrical leads that may energize active components associated within the wells.

When wells are also used for imaging such as in a multi-well biological plate, the optical characteristics of the glass may be particularly important, for example, with interferometry or spectroscopy applications. Refractive index striations (chord), bubbles, and surface imperfections generally may not be tolerated. Further, for many applications, but especially those involving subsequent microstructure additions, precision dimensional tolerances of the overall plate of less than 0.1 mm may be required.

When additional components may be included in the well structure, such as electrodes or other thin film devices such as thin film transistors, organic light emitting diodes (OLEDs), or photovoltaics as part of a product, a smooth surface without asperities may be essential. Typically, these surfaces may need to be less than 2 nanometer (nm) root-mean-square (RMS) roughness with maximum peak to valley variations of less than 25 nm. It is desirable that these characteristics can be achieved directly by the glass forming process, and the ability to polish the well structure for the product application may also be desirable.

Exemplary embodiments of the present disclosure relate to a repressed multi-well glass-containing structure, a system to form the repressed multi-well glass-containing structure, and methods of repressing glass-containing plate to make the multi-well structure.

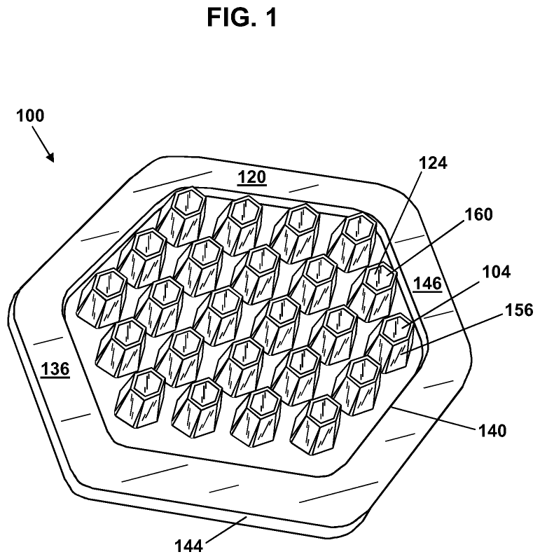

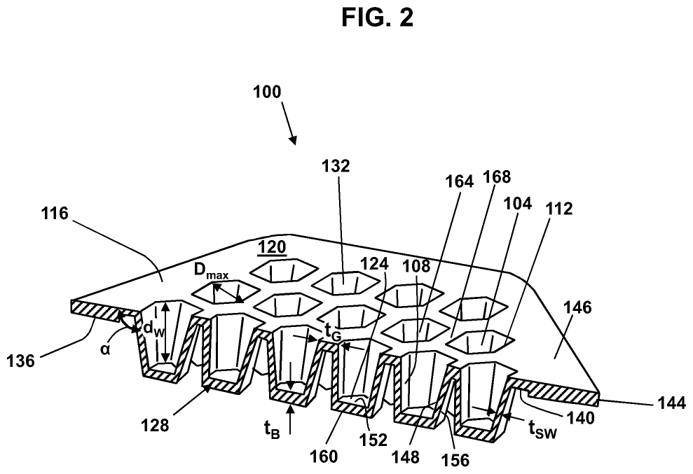

FIG. 1 is a bottom perspective view of a repressed glass-containing structure 100 made according to methods disclosed herein and after edge trimming according to an exemplary embodiment of the disclosure. FIG. 2 is a schematic cutaway diagram of the repressed structure 100 of FIG. 1 showing wall thickness t_{sw} and bottom thickness t_{B} of wells 104, and a gap t_{G} that spaces apart well walls 108 of adjacent wells 104 according to an exemplary embodiment of the disclosure. As used herein, glass-containing refers to glass materials that may contain other materials.

As illustrated in FIGS. 1 and 2 the repressed glass-containing structure 100 can be a molded glass plate 120 and include at least one well 104. The at least one well 104 can include at least one wall 108 that extends from a top rim 112 at a top surface 116 of the plate 120 to a well bottom 124 at the bottom of the plate 128. A major portion of the well wall 108 can be at a steep angle, alpha (a), to the top surface 116, for example, greater than about 105 degrees, for example, greater than about 96 degrees, or even, greater than about 95 degrees. The top rim 112 at the top surface of the plate 116 can define a well opening 132. While the glass-containing structure 100 molded glass plate 120 is illustrated as having a plurality of wells 104, in some embodiments, the structure 100 can be a single well 104 structure 100.

The molded glass plate 120 can include a bottom surface 136 opposite the top surface 116, additional molded features 140 such as alignment and dicing notches, a repressed glass plate edge 144, and an edge region 146. The well 104 can have inner surfaces such as a wall inner surface 148 and a well bottom inner surface 152. The well wall 108 can have an outer surface 156 opposite the well wall inner surface 148 that defines a well wall thickness t_{sw} between the two surfaces 148 and 156. The well wall 108 can have a thickness t_{sw} between about 50 microns and 1.5 mm. For example, t_{sw} can be between about 50 microns and 500 microns. For example, t_{sw} can be between about 50 microns and 250 microns. The well bottom 124 can have an outer surface 160 opposite the well bottom inner surface 152 that defines a well bottom thickness t_{B} between the two surfaces 152 and 160. The well bottom thickness t_{B} can be about the same as the well wall 108 thickness t_{sw}, or even thinner by about 20% or thicker by about 80%.

The embodiment of the glass-containing structure 100 of the molded glass plate 120 can have a plurality of wells 104 as shown in FIGS. 1 and 2. For example, the glass plate 120 can have multiple wells 104 with the wells forming an array of frustums, all of which may have substantially the same wall thickness on surfaces parallel to a reference plane, and thinner on surfaces which are non-parallel to the reference plane. For example, the reference plane can be a major plane of the initial glass sheet prior to pressing, for example, top surface 116 in FIG. 2. Wall thicknesses parallel to the reference frame can include, for example, the well bottom 124. The well side walls 108 become thinner as the glass is stretched when it is pressed. The variation in thickness depends on the depth of the well relative to the thickness in the reference plane. FIG. 1 shows an array of such corrugations which have a hexagonal frustum shape. The hexagonal shaped wells can be in a close-packed hexagonal arrangement. Shapes such as hexagonal, pentagonal, triangular, rectangular, and circular frustums are also possible. Where a minimum of space between wells is desired, plane-filling shapes such as hexagons, squares, rectangles, and triangles can be used. The well 104 can have a shape in the form of any of a circular frustum, an oval frustum, an asymmetrical frustum, a symmetrical frustum, a triangular frustum, a rectangular frustum, a hexagonal frustum, another polygonal frustum, or a combination thereof. Further, the well 104 need not be limited to a frustum, for example, the well bottom 124 shape can be flat with sharp or rounded corners at the well wall 108, or, for example, conical, aspherical, spherical, and cylindrical.

A 24 well hexagonal array is shown in FIG. 1, however, the number of wells in an array is not particularly limited and can be, for example, seven arranged in a hexagonal close-packed arrangement. Further, the wells can be arranged in other arrangements, for example, in a square or rectangular array, for example, in a 1×1 array, a 4×4 array, a 5×5 array, a 10×10 array, etc.

The well 104 at the top surface 116 can be spaced apart from an adjacent well 164 by a divider region 168 where well walls 108 meet. Well walls 108 extend from the top surface 116 spaced apart from well walls 108 of adjacent wells 104 by a gap t_{G}. The gap t_{G} can be at least one wall thickness wide, for example, about 1 mm wide. For example, the gap t_{G} can be at least one wall thickness wide at the plate bottom 128. The gap t_{G} can prevent cross-talk between wells in applications such as light emitting diodes (LEDs), electrical addressing, and the like. In applications having a shared wall, light and/or current could possibly leak from one well to the adjacent well. However the gap t_{G} provides a barrier to cross-talk between adjacent wells. In some instances, the well wall surface can be opaque to guide light out of the well instead of uncontrolled transmission in the well wall.

For some applications, it may be useful to have well plates 120 with a high open surface area, defined as the well opening area 132 divided by the total area of the well plate 120 occupied by the array of wells 104 (well occupied area), and a high well aspect ratio, AR, defined as the ratio between the depth of the well d_{w} divided by the maximum surface dimension Dₘₐₓ of the well opening 132, and a large contained volume ratio, defined as the ratio of the volume of the wells divided by the total volume of the well plate. The maximum surface dimension Dₘₐₓ of the well opening can be used to calculate the opening area of the well 104 at the top surface 116. The well occupied area can be the area of the glass well plate 120 within a molded feature such as molded feature 140 in FIGS. 1 and 2. For example, the well occupied area can be the area of the glass well plate 120 within an outer periphery 156 of the outer most well walls 108. Glass well plates 120 can be achieved with the repress process disclosed below according to exemplary embodiments, having an open surface area of at least 60% and up to 85%, well aspect ratios AR=d_{w}/Dₘₐₓ×100%, of at least 40% and up to 100%, and contained volume ratios of at least 40% and up to 70%.

Some applications of the well plate 120 can require the deposition of thin film electrodes, such as indium tin oxide to about 150 nm, on the well walls 108. In these cases, it may be desirable to have a smooth inner surface 148 and/or outer surface 160 on the wall 108, as measured by the average roughness, Ra. For example, it may be difficult to deposit a thin film of 50 nm to 150 nm on a surface having an average roughness Ra of about 1 mm. It can be appreciated that unlike planar surfaces, polishing the inside surface of a small well can be difficult by conventional glass polishing techniques. Conventional glass pressing processes can produce parts with Ra in excess of 1 micron due to interaction of the mold with the still-viscous glass and mold release agents. In contrast, the sheet reforming processes disclosed herein can produce glass structures having surfaces with Ra less than about 600 nm, for example, Ra can be less than about 250 nm, Ra can be even less than about 60 nm, further, Ra can be even less than about 10 nm. An inner surface 152 and 148 of the well 104 can have an average roughness Ra, of Ra less 600 nm, less than 250 nm, less than 60 nm, or even less than 10 nm as measured by profilometer ZYGO™ New View 7300™ instrument. An outer surface 160 and 156 of the well 104 can have an average roughness Ra, of Ra less 600 nm, less than 250 nm, less than 60 nm, or even less than 10 nm as measured by profilometer ZYGO™ New View 7300™ instrument. Furthermore, the open end of the glass plate 120 can have a flat top surface 116 having a Ra less than 600 nm.

While not wishing to be bound by theory, a profilometer (e.g., ZYGO™ New View 7300™) is an interference microscope that measures height variation, or roughness and waviness, of a sample's surface by optical profiling. A light beam is split, reflecting half of the beam from the sample's surface and the other half is reflected from a reference mirror. Interference fringes result when the split beam lengths are different. Since the reference mirror is flat, the optical path differences are due to the surface's topography. Knowing the wavelength allows the height differences to be calculated in fractions of a wave. The Roughness average, Ra, is an arithmetic average of the absolute values of the profile height deviations from the mean line (Z), recorded across a sampling length (I):

$$Ra = \frac{1}{l} {\int }_{0}^{l} \vert Z ( x ) \vert dx$$

In some embodiments, the well plate 120 has a first main surface including the top of the plate 116 and the inner surfaces 148 and 152 of the at least one well 104, as described herein, and a second main surface opposed to the first main surface, where the second main surface includes, for example, the bottom surface of the repressed plate 136, the outer surface 156 of the well 104 side wall 108, and the outer surface of the well bottom 160. At least one of the first main surface and the second main surface can be ion strengthened. For example, the ion strengthened main surface can be ion strengthened before the glass plate 120 is repressed, or after the glass plate is repressed. Repressing is described in more detail below, and can also be referred to herein as forming, reforming, and/or molding. At least one of the first main surface and the second main surface can be strengthened by other processes, such as a laminate process with a compressive top layer to strengthen the glass plate 120.

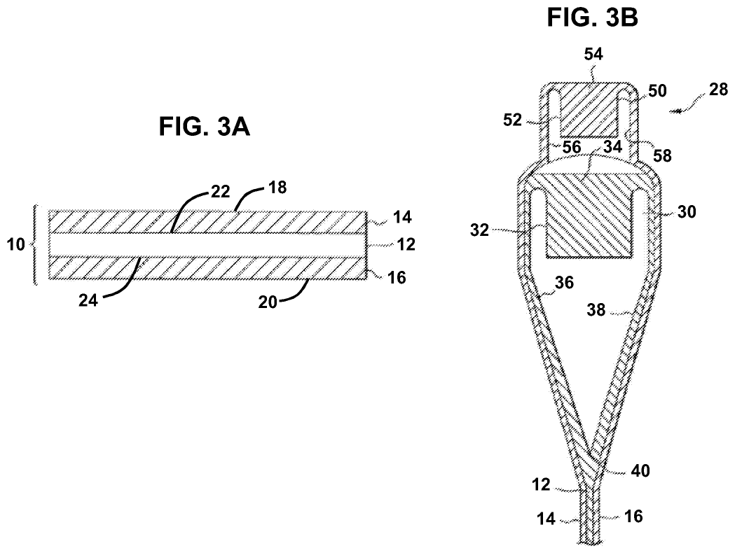

Examples of a laminate and a laminate process are shown in FIGS. 3A and 3B. FIG. 3A is a cross-sectional view of an exemplary embodiment of a laminated glass article 10. In some embodiments, glass article 10 may comprise a laminated sheet comprising a plurality of glass layers. The laminated sheet can be substantially planar as shown in FIG. 3A or non-planar. Glass article 10 may comprise a core layer 12 disposed between a first cladding layer 14 and a second cladding layer 16. In some embodiments, first cladding layer 14 and second cladding layer 16 may be exterior layers as shown in FIG. 3A. For example, an outer surface 18 of first cladding layer 14 may serve as an outer surface of glass article 10 and an outer surface 20 of second cladding layer 16 may serve as an outer surface of the glass article. In other embodiments, the first cladding layer and/or the second cladding layer may be intermediate layers disposed between the core layer and an exterior layer.

Core layer 12 may comprise a first major surface and a second major surface opposite the first major surface. In some embodiments, first cladding layer 14 may be fused to the first major surface of core layer 12. Additionally, or alternatively, second cladding layer 16 may be fused to the second major surface of core layer 12. In such embodiments, an interface 22 between first cladding layer 14 and core layer 12 and/or an interface 24 between second cladding layer 16 and core layer 12 may be free of any bonding material such as, for example, an adhesive, a coating layer, or any non-glass material added or configured to adhere the respective cladding layers to the core layer. Thus, first cladding layer 14 and/or second cladding layer 16 may be fused directly to core layer 12 or may be directly adjacent to core layer 12. In some embodiments, the glass article may comprise one or more intermediate layers disposed between the core layer and the first cladding layer and/or between the core layer and the second cladding layer. For example, the intermediate layers may comprise intermediate glass layers and/or diffusion layers formed at the interface of the core layer and the cladding layer. The diffusion layer can comprise a blended region comprising components of each layer adjacent to the diffusion layer (e.g., a blended region between two directly adjacent glass layers). In some embodiments, glass article 10 may comprise a glass-glass laminate (e.g., an in situ fused multilayer glass-glass laminate) in which the interfaces between directly adjacent glass layers are glass-glass interfaces.

In some embodiments, core layer 12 may comprise a core glass composition, and first and/or second cladding layers 14 and 16 may comprise a clad glass composition that is different than the core glass composition. The core glass composition and the clad glass composition may be different from each other prior to subjecting the glass article to any type of chemical strengthening treatment as described herein. For example, in the embodiment shown in FIG. 3A, core layer 12 may comprise or be formed from a first glass composition, and each of first cladding layer 14 and second cladding layer 16 may comprise or be formed from a second glass composition. In other embodiments, the first cladding layer may comprise or be formed from the second glass composition, and the second cladding layer may comprise or be formed from a third glass composition that is different than the first glass composition and the second glass composition.

The glass article may be formed using a suitable process such as, for example, a fusion draw, down draw, slot draw, up draw, or float process. In some embodiments, the glass article may be formed using a fusion draw process. FIG. 3B is a cross-sectional view of one exemplary embodiment of an overflow distributor 28 that can be used to form a glass article such as, for example, glass article 10. Overflow distributor 28 can be configured as described in U.S. Pat. No. 4,214,886, which is incorporated herein by reference in its entirety. For example, overflow distributor 28 may comprise a lower overflow distributor 30 and an upper overflow distributor 50 positioned above the lower overflow distributor. Lower overflow distributor 30 may comprise a trough 32. A first glass composition 34 may be melted and fed into trough 32 in a viscous state. First glass composition 34 may form core layer 12 of glass article 10 as further described below. Upper overflow distributor 50 may comprise a trough 52. A second glass composition 54 may be melted and fed into trough 52 in a viscous state. Second glass composition 54 may form first and second cladding layers 14 and 16 of glass article 10 as further described below.

In the fusion draw process, first glass composition 54 may overflow trough 32 and flow down opposing outer forming surfaces 36 and 38 of lower overflow distributor 30. Outer forming surfaces 36 and 38 converge at a draw line 40. The separate streams of first glass composition 34 flowing down respective outer forming surfaces 36 and 38 of lower overflow distributor 30 may converge at draw line 40 where they are fused together to form core layer 12 of glass article 10.

In the fusion draw process, second glass composition 54 may overflow trough 242 and flow down opposing outer forming surfaces 56 and 58 of upper overflow distributor 50. Second glass composition 54 may be deflected outward by upper overflow distributor 50 such that the second glass composition flows around lower overflow distributor 30 and contacts first glass composition 54 flowing over outer forming surfaces 36 and 38 of the lower overflow distributor. The separate streams of second glass composition 54 may fuse to the respective separate streams of first glass composition 34 flowing down respective outer forming surfaces 36 and 38 of lower overflow distributor 30. Upon convergence of the streams of first glass composition 34 at draw line 40, second glass composition 54 may form first and second cladding layers 14 and 16 of glass article 10.

The laminate glass article 10 formed by the described fusion draw process may be mechanically strengthened by the coefficient of thermal expansion (CTE) of first cladding layer 14 and/or second cladding layer 16 being lower than the CTE of core layer 12.

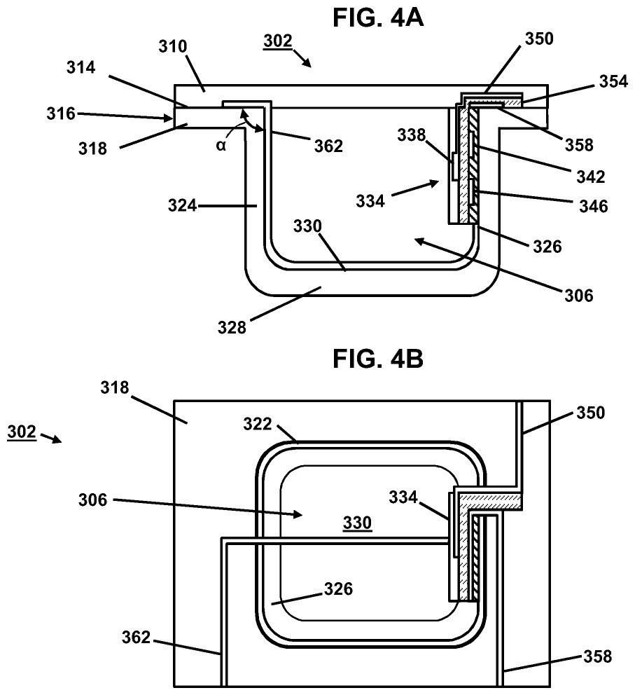

Referring to illustrated embodiments in FIGS. 4A and 4B, a cover glass can be disposed on the top surface 116 of the glass plate 120 to hermetically seal the well 104.

FIG. 4A is a schematic side-view diagram of a hermetically sealed glass well having electronic leads extending into the well according to an exemplary embodiment and FIG. 4B is a schematic top-view diagram of the hermetically sealed glass well of FIG. 4A. The hermetically sealed well 302 has a glass well 306 and a cover sheet 310, for example, a glass cover sheet, hermetically sealed to the top surface 314 of the repressed glass plate 316 having the well 306. The well plate 316 can have an edge region 318 and a hermetic seal 320 to bond the glass well 306 and the cover sheet 310. The hermetically sealed well 302 can have well rim 322, well side wall 324 having a well side wall inner surface 326, well bottom 328 having a well bottom inner surface 330 as described previously with reference to FIGS. 1 and 2. In addition, an electronic device 834 may be disposed on the inner surface 326 and/or 330 of the glass well 306. For example, a thin film transistor (TFT) 334 may be disposed on the inner surface 326 and/or 330 of the glass well 306, as part of a pixel, OLED, detector, and the like. The TFT can have a gate 238, source 358, and drain 346, for example. In some embodiments, an electronic layer including electrically conductive pathways can be disposed on the inner well wall 326, the outer well wall, the inner well bottom 330, the outer well bottom or a combination thereof.

When the cover glass 310 disposed on the top surface 314 can hermetically seal the at least one well 306, at least one electrode conductor path, such as a gate electrode 350, source electrode 358, and a drain electrode 362 can be hermetically sealed and conduct charge through the hermetic seal. An insulation layer 354 may also be present and hermetically sealed, for example, between electrodes as illustrated in FIGS. 4A and 4B.

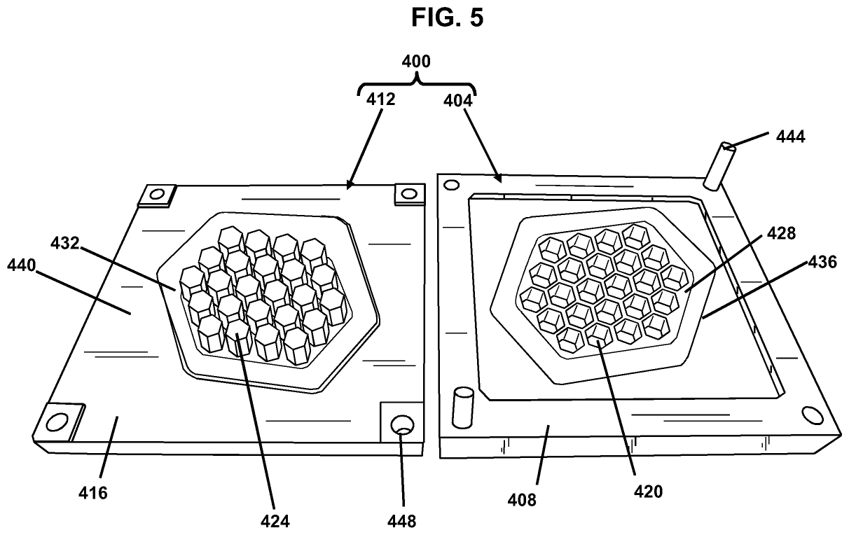

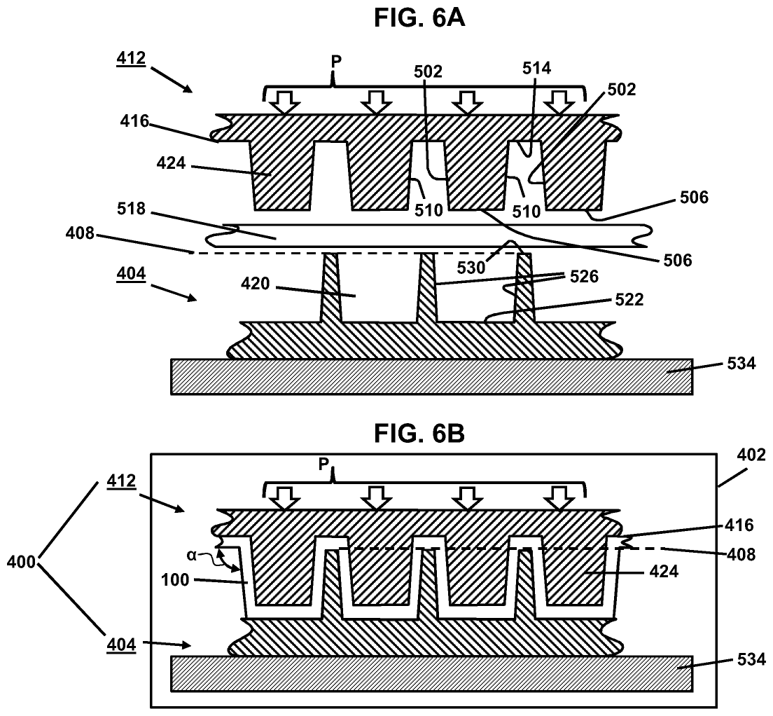

Another exemplary embodiment discloses a system to manufacture a glass-containing multi-well structure 100. The system can include a mold 400 (FIG. 5), a furnace 402 (FIG. 6B), and a pressing element P (FIGS. 6A and 6B). The mold 400 can have at least one surface cavity 420 and a coefficient of thermal expansion that substantially matches a coefficient of thermal expansion of a glass-containing sheet 518 to be disposed on a surface comprising the surface cavity 420. The furnace 402 can be configured to heat the mold 400 having the glass-containing sheet 518 disposed thereon to a forming temperature corresponding to a viscosity of about 10⁵ poises to about 10^{7,6} poises of the glass-containing sheet 518. The pressing element P can be configured to press the glass-containing sheet 518 at the forming temperature to conform to the at least one surface cavity 420. The at least one surface cavity 420 can be configured to form the glass-containing sheet into at least one well 104, the at least one well 104, as described above, can have a well aspect ratio, AR of the depth of the at least one well, d_{w}, to a maximum surface dimension of an open area of the at least one well Dₘₐₓ, AR=d_{w}/Dₘₐₓ×100% in a range from 40% to 100%, and an inner surface of the at least one well can have an average roughness measured by profilometer ZYGO™ New View 7300™ instrument, Ra, of Ra<600 nm, for example, <250 nm, <60 nm, or even less than 10 nm.

The pressing element P can be a vacuum that removes atmosphere from under the glass-containing sheet 518 so that atmosphere on top of the glass-containing sheet 518 presses the glass-containing sheet 518 into the mold cavity 420. In the embodiments, the pressing element P can be a weight, hydraulic, or mechanical load, applied to a top mold component 408 as described in more detail below.

FIG. 5 is a schematic diagram of a mold 400 having top 412 and bottom 404 components and alignment pins 444 according to an exemplary embodiment of the disclosure. The mold 400 can have top and bottom plates 404 and 412, one of which is the negative image of the other for a multi-well structure. The bottom component 404 can be a female half of the mold 400 having a female mold surface 408 and the top component 412 can be a male half of the mold 400 having a male mold surface 416. The female mold surface 408 can have a well cavity 420, or a plurality of well cavities disposed in an array. The male mold surface 416 can have inverse features of the well cavity 420, such as cavity pins 424. Other features 428 on the female mold surface 408 can include dicing features, a dam 436 to guide glass distribution, and the like. The male mold surface 416 can have matching inverse features 432, such as dicing features and glass distribution control feature 440. For smaller details, for example, less than 1 mm in cross section, the feature may be only in one of the mold surfaces 48 and 416. The top 412 and bottom 404 mold components can have guide pins 444 disposed in guide holes 448 to guide the top 412 and bottom 404 mold components when pressed together at temperature with a glass sheet 518 to be formed disposed between the mold surfaces 408 and 416.

In a method of manufacturing a multi-well structure 100 such as shown in FIGS. 1 and 2, according to an exemplary embodiment, the sheet comprised substantially of glass 518 can be disposed on the mold 404 having at least one surface cavity 420. Referring to FIGS. 5, 6A, and 6B, the mold 400 can have a first coefficient of thermal expansion and the sheet 518 can have a second coefficient of thermal expansion substantially the same as the first coefficient of thermal expansion. The mold 400 can be a precision graphite mold with predetermined graphite materials adapted to different glass and physical property requirements as described further below. The glass sheet 518 can be prepared to a predetermined size and thickness, preferably formed by the fusion draw process, but other forming techniques such as slot draw, float, rolling, or the like can be used. The glass sheet 518 initial thickness can range from 0.5 mm to 5 mm.

As described herein, thin glass sheet 518 can be repressed between two nonstick molds 404 and 412, generally made of graphite. Mold materials can include non-stick materials such as graphite and boron nitride (BN). The mold components 404 and 412 can be positive and negative images of each other, except for small details, for example, less than 1 mm in cross section, which may be formed in either the top 412 or bottom 404 halves of the mold 400.

Pressing can be operated in isothermal conditions, that is, where the mold 400 and glass 518 are at substantially the same temperature.

The coefficient of thermal expansion (CTE) of the mold 400 can match the CTE of the glass 518 in order to prevent any breakage during cooling and removal from the mold 400. Graphite may be formulated to have CTE's in the range of 3-9 ppm/° C. which can permit a wide range of glasses. For low expansion alkaline earth aluminum borosilicates such as CORNING™ EAGLE XG™ or JADE™ glass, Graphite grade 2020 from MERSEN™ is a good choice. For high expansion alkali glasses such as CORNING™ GORILLA™, graphite grade EDM4™ from POCO™ may be successfully used.

A wide variety of glass compositions may be found with thermal expansion coefficients in the range of 3-9 ppm/° C. These include alkaline earth aluminosilicates and certain alkali borosilicates. Higher expansion glasses such as sodium calcium aluminosilicates (soda lime or window glass) can be used, but may be subject to higher breakage rates if not handled with additional care. Glass compositions are preferred that can be formed into a sheet. It will be appreciated that there are many ways of creating a glass sheet ranging from simple pouring of the glass on a steel table, then grinding to the appropriate thickness, to sophisticated techniques such as fusion draw. Floating on tin baths, slot drawing, redrawing, and rolling are examples of other means to create a planar glass sheet.

Glass laminate compositions are disclosed, for example, in U.S. Pat. No. 5,100,452, issued Mar. 31, 1992, and U.S. Pat. No. 5,342,426, issued Aug. 30, 1994 the contents of which are both hereby incorporated by reference for all purposes as though fully set forth herein, that cover ranges of CTEs of glass laminate compositions from approximately 4×10⁻⁷ to 9×10⁻⁷ ppm/° C.

The method can include heating isothermally the mold 400 and the sheet 518 to a predetermined temperature, wherein the predetermined temperature corresponds to a viscosity of about 10⁵ poises to about 10^{7,6} poises of the glass sheet 518. The method can include applying molding pressure P to the sheet 518 to force the sheet 518 to conform to the at least one surface cavity 420, holding the sheet 518 disposed on the mold 400 under the applied pressure P for about 10 to 60 minutes, cooling the sheet 518 disposed on the mold 400, and removing the sheet 518 from the mold 400. When removed from the mold 400, the sheet 100 can have at least one well 104 corresponding to the at least one surface cavity 420.

The glass sheet 518 can be preheated to a temperature corresponding to its softening point: 10^{7,6} poises. For glasses such as JADE™, this corresponds to a temperature of about 1025° C., whereas for PYREX™ it would correspond to about 750° C.

Uniform pressure P can be applied on top mold 412 by a mechanical apparatus or a dead weight. The pressure P can be, for example, 10⁻² to 10⁻³ N/cm².

The well 104 can have a well aspect ratio, AR of the depth of the at least one well, d_{w}, to a maximum surface dimension of an open area of the at least one well Dₘₐₓ, AR=d_{w}/Dₘₐₓ×100% in a range from 40% to 100%, as described above, and the inner surface of the at least one well 104 can have an average roughness measured by profilometer ZYGO™ New View 7300™ instrument, Ra, of Ra<600 nm, for example, <250 nm, <60 nm, or even less than 10 nm.

A glass reforming process to produce glass well plates using a glass sheet reforming process is described, for example, in U.S. Pat. No. 8,156,762, issued Apr. 17, 2012, the entire contents of which is hereby incorporated by reference as though fully set forth herein.

The glass sheet 518 can be pressed by a pin end face 506 on a top surface into each well cavity 420. A bottom surface of the glass plate 518 can press into the well cavity bottom 522. A counter plate 534 can support the bottom mold 404. The well bottom 124 thickness t_{B} can be determined by the distance between the pin end face 506 and the well cavity bottom 522. The glass sheet 518 can be stretched and thinned as it is pressed between the pin end face 506 and the well cavity bottom 522. Pin side walls 502 and 510 can press the glass sheet 518 into well cavity side surface 526 to form well wall 108. The well wall 108 can have a thickness t_{sw} determined by the distance between the pin side walls 502 and 510 and the well cavity side surface 526. The glass sheet 518 can be stretched and thinned as it is pressed between the pin side walls 502 and 510 and the well cavity side surface 526. The top mold surface 416 between the pins 424 divider region 514 can press the glass sheet 518 against a divider region 530 on the bottom mold surface 408 to form the divider region 168 where well walls 108 meet at the top surface 116 of the repressed multi-well glass plate 120. The glass sheet 518 can be stretched and thinned as it is pressed between surfaces 514 and 530.

The glass sheet 518 formed into the multi-well structure 100 can be removed from the mold 400 and additional operations such as trimming, surface polishing, and singulation can be performed.

Conventional techniques may be used for polishing the surfaces. Coarse grinding may generally not be necessary when the mold surfaces were well finished. Hand polishing or double sided lap polishing may be accomplished on conventional grinding and polishing machines using free abrasive powder (SiC) for grinding and cerium oxide on a polyurethane pad for polishing.

In the embodiment, the glass sheet 518 can be up to at least 400×500 mm so that many wells 104 can be formed in a single sheet. The repressed glass sheet 100 can faithfully reproduce the features of the mold, so desired features may be scaled down to less than 0.25 mm, and may be limited only by a capability of machining the mold 400. It will be appreciated that multiple parts 120, each with multiple wells 104, can be processed as a single sheet 518, and then separated using conventional singulation technology such as scribe and break, laser cutting, or diamond saw cutting. Moreover, these processes may be assisted by including fiduciary features, such as edge grooves 436 and 440, in the mold 400.

Improvements to the as-pressed surface roughness can be accomplished by polishing specific features of the carbon mold 400 according to the exemplary embodiments. For example, if increased smoothness is desired on the inside surface of the well 148 and 152, then the mold 400 features which are responsible for the well 104 may be polished independently of the rest of the mold 400. An approach to polishing these surfaces can be, for example, to use successively finer grades of silicon carbide paper. One preferred exemplary sequence can be to use mesh 600 paper followed by mesh 1200 paper, followed by 12 micron paper, followed by 9 micron paper, and finished with 3 micron paper. It will be appreciated that use of fine grained, highly densified graphite mold material can aid this process.

According to exemplary embodiments, further improvements to the as-pressed surface roughness can be accomplished by using a laminate glass consisting of an acid-dissolvable cladding and an acid-durable core as the glass sheet 518 in the described process above. Such a laminate glass sheet may be made by a variety of methods including fusion draw and hot ribbon lamination, and stacking of individual sheets followed by fusion. Following removal from the mold 400, the glass structure 100 can be placed in an ultrasonically agitated acid bath consisting of HCl at 50 volume percent concentration at 60° C. and left until the cladding glass has dissolved, typically about 30 minutes. This can be referred to as the lost glass process. The resulting surface has never touched a mold, but still retains the dimensional accuracy and features as the non-laminated and etched multi-well structure 100. Surface roughness, Ra, of less than 60 nm have been obtained with this approach.

Lost glass process is described in part in U.S. Pat. No. 5,342,426, issued Aug. 30, 1994, the entire contents of which is hereby incorporated by reference for all purposes as though fully set forth herein. Alkali-free core and cladding glass compositions disclosed therein can be useful for an electrically active device such as an OLED, photovoltaic, or liquid lens.

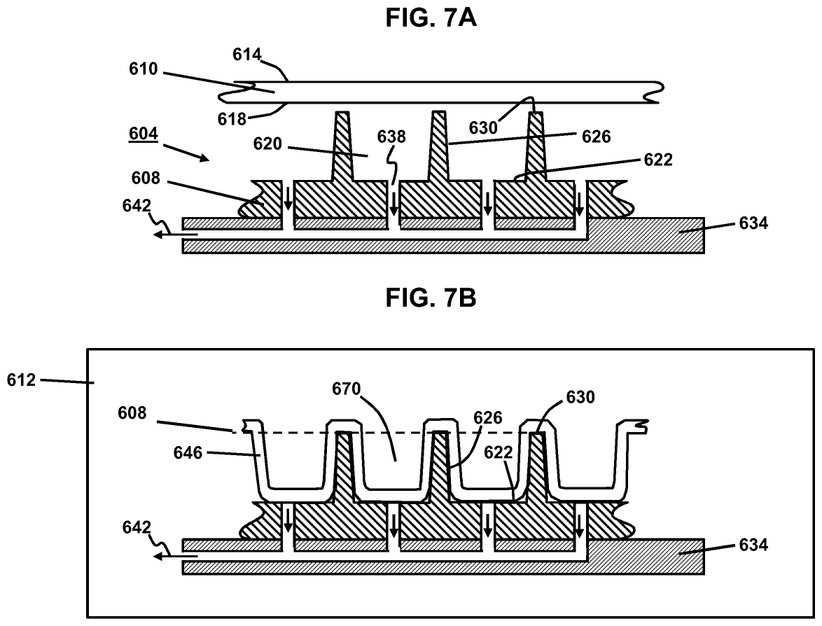

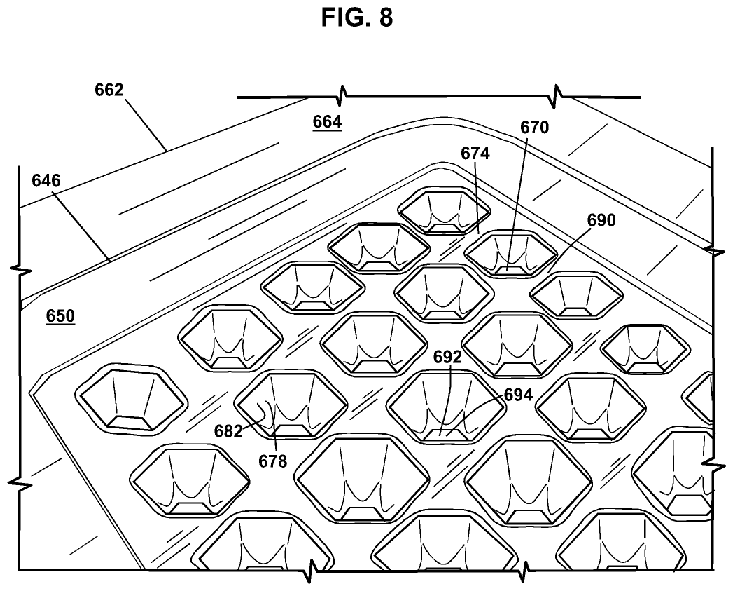

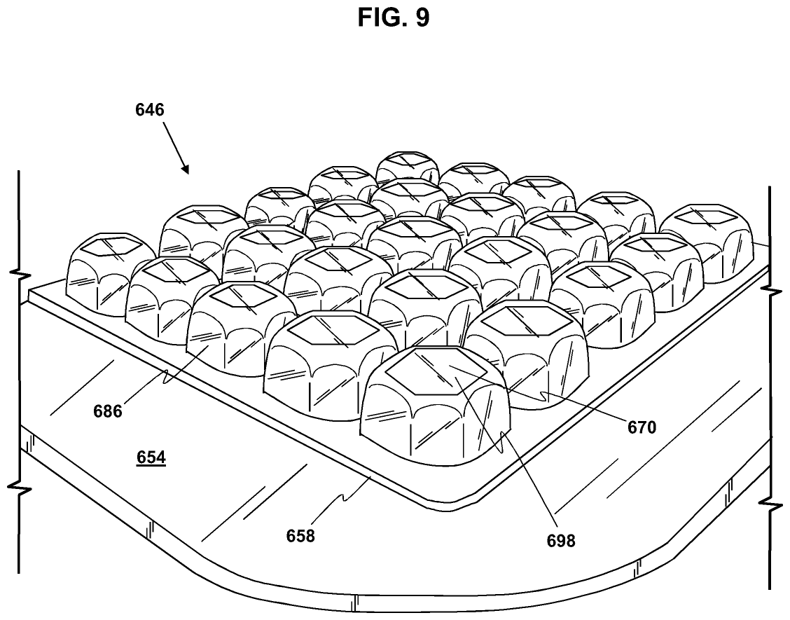

Referring now to FIGS. 7A, 7B, 8 and 9 surfaces of low average roughness Ra can be obtained when no tool touches the glass surface. This may be possible at least for some surfaces when the mold is activated with a vacuum system and the glass sheet can be drawn down over the mold. FIG. 7A is a schematic cross-section of a system including a bottom mold component 604 having mold vacuum channels 638 in cavities 620 and having a glass sheet 610 disposed on a mold surface 608 according to an exemplary embodiment of the disclosure. FIG. 7B is a schematic cross-section showing the system of FIG. 7A after heating and pressing by drawing a vacuum under the glass sheet 610 between a bottom surface 618 of the glass sheet 610 and the mold cavities 620 according to an exemplary embodiment of the disclosure. For example, no top mold has pressed the glass sheet 610 into the cavities 620. FIG. 8 is a top perspective view of a repressed multi-well plate made according to methods disclosed herein according to an exemplary embodiment of the disclosure. FIG. 9 is a bottom perspective view of the repressed multi-well plate of FIG. 8.

The system according to the embodiment can include a vacuum system 642 and a support plate 634 such as a vacuum manifold, the mold 604 with vacuum plenums 638 that allow evacuation of air through the mold 604, and a heat source 612. The mold 604 can have a first coefficient of thermal expansion and the sheet 610 can have a second coefficient of thermal expansion substantially the same as the first coefficient of thermal expansion. The mold 604 can be a precision graphite mold with predetermined graphite materials adapted to different glass and physical property requirements as described above. The glass sheet 610 can be prepared to a predetermined size and thickness, preferably formed by the fusion draw process, but other forming techniques such as slot draw, float, rolling, or the like can be used. The glass sheet 610 initial thickness can range from 0.5 mm to 5 mm. The method can include heating isothermally the mold 604 and the sheet 610 to a predetermined temperature, wherein the predetermined temperature corresponds to a viscosity of about 10⁵ poises to about 10^{7,6} poises of the glass sheet 610.

The method can include applying vacuum 642 to the sheet 610 to force the sheet 610 to conform to the at least one surface cavity 620, holding the sheet 610 disposed on the mold 604 under the applied vacuum 642 for about 10 to 60 minutes, cooling the sheet 610 disposed on the mold 604, and removing the sheet 610 from the mold 604. When removed from the mold 604, the sheet 646 can have at least one well 670 corresponding to the at least one surface cavity 620. The glass sheet 610 can be pressed by vacuum 642 into each well cavity 620. A bottom surface of the glass plate 618 can press into the well cavity bottom 622. The well bottom 692 thickness t_{B} can be determined by how much the glass sheet 610 was stretched and thinned as it was pressed into the well cavity bottom 622 by the vacuum 642 and gravity. The bottom surface of the glass plate 618 can press into the well cavity side surface 626 to form well wall 678. The well wall 678 can have a thickness t_{sw} determined by how much the glass sheet 610 stretched and thinned as it was pressed into the well cavity side surface 626 by the vacuum and gravity. No top mold presses the glass sheet top surface 614 into well cavity side surface 626, bottom surface 622, or divider region 630 between cavities 620 so that the well walls 678, bottom 692 and corners may be rounded as shown in FIGS. 8 and 9.

The repressed plate 646 can have a top surface 650 and an opposite bottom surface 654, a molded feature 658, a plate edge 662, and a plate edge region 664. The repressed plate 646 can have an array of wells 670, each having a well rim 674 at the top surface 650 to define a well opening, and a well wall 678 extending from the well opening to a well bottom 692. In some instances, the well wall 678 and the well bottom 692 may form a continuous rounded structure and in others, there may be a sharp corner where the well wall 678 meets the well bottom 692. In some instances, an opening may be formed in the well bottom 692 and/or the well wall 678. The well wall 678 can have an inner surface 682 formed from the top surface 614 of the glass sheet 610, and an outer surface 686 formed from the bottom surface 618 of the glass sheet 610. The well wall 678 can have a thickness t_{sw} from the inner surface 682 to the outer surface 686. The well bottom 692 can have an inner surface 694 formed from the top surface 614 of the glass sheet 610, and an outer surface 698 formed from the bottom surface 618 of the glass sheet 610. The well bottom 692 can have a thickness t_{B} from the well bottom inner surface 694 to the well bottom outer surface 698.

The well 670 at the top surface 650 can be spaced apart from an adjacent well 670 by a divider region 690 where well walls 678 meet. Well walls 678 extend from the top surface 650 spaced apart from well walls of adjacent wells by a gap t_{G}. The gap t_{G} can be at least one wall thickness wide. For example, the gap t_{G} can be at least one wall thickness wide at the plate bottom.

The glass sheet 610 formed into the multi-well structure 646 can be removed from the mold 604 and additional operations such as trimming, surface polishing, and singulation can be performed. Improvements in the as-pressed surface roughness can be improved as mentioned above.

To avoid unwanted features on the mold side of the resultant glass sheet 646, a porous carbon can be used for fabricating the mold 604. Moreover, vacuum plenums 638 can be provided to within 3 mm of the mold surface.

According to the embodiments, the free surface of the glass sheet 614 has no contact with a tool, and it can faithfully conform to the shape of the mold 604. However, precise features may not be incorporated into the free surface 614 as it flows and stretches over the mold 604. Only the portion of the lower surface 618, for example, that touches the mold 604 can be held to high tolerance. Further, the lower surface 618 may be a laminate that can be etched away in the lost glass process resulting in inner and outer surfaces of very low average roughness Ra.

According to exemplary embodiments of the disclosure, the use of thin glass can provide repressed glass structure having a thin cross section. The thin glass sheet provides lower weight structures compared to conventional glass pressing. The lower weight structures can provide lower mechanical requirements for packaging the glass structure and reduce any mechanical demands of mounting elements.

According to the embodiments, the repressed structure surface can be smooth to enable subsequent steps such as photolithography, frit bonding, and laser welding on the surface. The smooth surface can also provide good optical transmission through the well, as well as a low scattering surface. Smooth inside well surfaces can be provided by dense carbon mold material. Compared to well structures that are made by conventional hot gob pressing, which may have chill wrinkles, other surface roughness, and limited dimensional precision, the well structures according to the exemplary embodiments can have smooth surfaces and high dimensional precision.

According to some of the embodiments the repressed structure can have flat, parallel reference surfaces that can provide precision alignment of the structure in a support system and can provide for a reference plane on which to locate, for example, a flat cover glass that requires very small gaps to achieve sealing. Hermetic sealing techniques such as laser welding and frit bonding having such requirements can be achieved using the repressed structure of the embodiments.

According to some of the embodiments the repressed structure can have thin side walls with wall thicknesses as low as 50 microns demonstrated without resorting to the lost glass process described above. Thin side walls, for example, can enable electrodes external to the well to be used to generate electric fields through the wall to act upon materials inside the well. Thin, corrugated walls can allow better thermal transport between the inside of the well and the exterior environment. Even thinner side walls can be achieved using the lost glass process when the interior member of the three layer laminate is kept very thin, for example, less than 50 microns in a 1 mm thick laminate.

It may be important in some optical applications such as OLEDs, photovoltaics, and liquid lens arrays to have a high areal filling of the surface by wells (well occupied area). This is because light falling on the area between the wells can be essentially lost by optical waveguiding. By making the space between the wells thin, the light lost to waveguiding can be minimized. The loss for an array of square wells can be represented by:

$$L = \frac{{( c + t )}^{2} - {c}^{2}}{{( c + t )}^{2}}$$

where L is the loss, c is the well dimension and t is the wall thickness. To reduce the loss to 10% of the incident light on a 10 mm square well, the exposed wall thickness should be about 0.5 mm or less. Creating such thin walls by conventional molten glass forming can be difficult, for example, because the glass cannot flow into the narrow channels. However, with sheet-formed well plates, that is, repressed glass sheet according to the exemplary embodiments herein, all the glass needed for the walls can already be in place and only needs to be stretched in the positive/negative mold to achieve such a low exposed wall thickness.

According to exemplary embodiments, precision dimensional tolerances on features such as well dimensions can be controlled to within +/−10 microns and can be controlled, for example, by the precision of the mold machining.

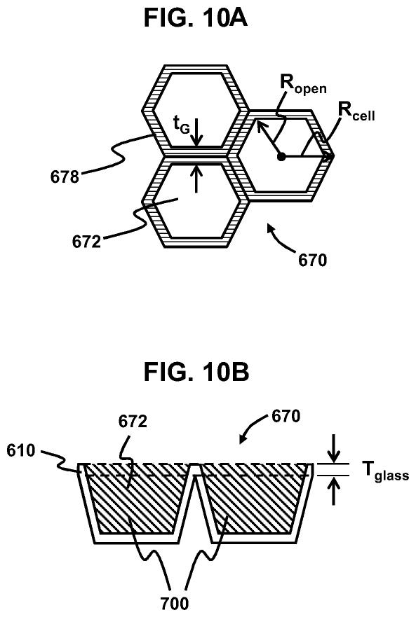

In an example, for illustrative purposes only, and not intended to be limiting, referring to FIGS. 10A and 10B, a hexagonal well 672 in the array of wells 670 can have a maximum open dimension Dₘₐₓ of about 8 mm, such that a major radius, Rₒₚₑₙ, from the center to a corner is 4 mm. The area of a hexagon being A=R² ((3√3)/2) yields the well open area, Aₒₚₑₙ, as 41.57 mm². The well wall can be about 1 mm thick at the top surface such that the radius of the total well, including the wall, is Rₜₒₜₐₗ, is 4.58 mm and the total area of the well at the top surface including the well wall is Aₜₒₜₐₗ=54.5 mm². Thus, in such an example, the open fraction is 76.3% for each well. When the hexagonal wells are disposed in a close packed arrangement, for example, 24 hexagonal wells as shown in FIG. 1 and FIG. 10A, the total open well area of the 24 wells would be 997.7 mm² and the total occupied area of the cells would be 1308 mm² leading to an open area fraction of 76.3%. Here, the edge region 146 and the triangular areas between the outermost hexagonal well wall 108 outer surfaces 156 and molded feature 140 may not be considered to be part of the well occupied area. In the example, the well depth can be 8 mm and the well wall 108 can have a slope of about 6 degrees (i.e., a of about 96 degrees), such that the contained volume of an individual hexagonal frustum is given by V_{contained}=(h/3) (A_{base}+Aₜₒₚ+(A_{base} Aₜₒₚ)^{1/2}), where A_{base} and Aₜₒₚ are the areas of the base and top of a truncated frustum. When h=8 mm and the relief angle is 6 degrees, the radius R_{bottom} of the well bottom hexagon is (4 mm−(8/tan(90−6)°))=3.16 mm. A_{base} was calculated above as Aₒₚₑₙ equal to 41.57 mm, and Aₜₒₚ is 25.9 mm². Such that the volume of the hexagonal cell is 267 mm³.

Table 1 provides the parameters used in the example followed by the equations for calculating the contained volume ratio and the open area ratio.

TABLE 1

| Glass well plate well | | | |
|---|---|---|---|
| volume ratio | Parameter | value | units |
| Well calculation | | | |
| well separation | t_{G} | 1 | mm |
| well depth | h | 8 | mm |
| well major dimension | Rₒₚₑₙ | 4 | mm |
| well wall slope | alpha (α) | 84 | degrees |
| Glass thickness | T_{glass} | 2 | mm |
| Well | | | |
| Well base major dimension | A_{well} | 41.57 | mm² |
| Well base major dimension | R_{base} | 3.16 | mm |
| Area of well base | A_{base} | 25.93 | mm² |
| Volume of well | V_{well} | 267.55 | mm³ |
| Glass Frustum | | | |
| Major axis of glass hexagon | R_{cell} | 4.58 | mm |
| Glass surface hexagon (blue | A_{cell} | 54.44 | mm² |
| plus grey in figure) | | | |
| Major axis of glass base | R_{cellbase} | 3.74 | mm |
| Area of glass base | A_{cellbase} | 36.27 | mm² |
| Volume of glass frustum | V_{cell} | 360.38 | mm³ |
| Right Hexagon | | | |
| Major axis of hexagon | R_{cell} | 4.58 | mm |
| Area of hexagon | A_{cell} | 54.44 | mm² |
| Volume of right hexagon | V_{righthexagon} | 108.87 | mm³ |
| Total cell volume | Vₜₒₜₐₗ | 469.26 | mm³ |
| Contained volume ratio | R_{contained} | 57% | |
| Open area ratio | Rₒₚₑₙ | 76% | |

Open area Ratio calculation:

$${R}_{cell} = {R}_{open} + \frac{\frac{tG}{2}}{cos {30}^{0}}$$

$${R}_{cell} = 4 mm + \frac{\frac{1}{2}}{cos {30}^{0}} = 4.58 mm$$

$${A}_{cell} = {R}_{cell}^{2} \times \frac{3 \sqrt{3}}{2} = 58.4 {mm}^{2}$$

$${A}_{open} = {R}_{open}^{2} \times \frac{3 \sqrt{3}}{2} = 41.6 {mm}^{2}$$

$$Open Area Ratio = \frac{{A}_{open}}{{A}_{cell}} = 76 \%$$

The contained well volume 700 is:

$${V}_{well} = \frac{h}{3} ( {A}_{well} + {A}_{base} + \sqrt{{A}_{well} \times {A}_{base}} )$$

$${V}_{well} = \frac{8}{3} ( 41.6 + 25.9 + 32.8 )$$

$${V}_{well} = 267.5 {mm}^{2}$$

The total well volume consists of the lower frustum indicated by outer wall surface plus a riaht hexagon on the too shown in dashed lines of FIG. 10B:

$${V}_{cell} = {V}_{frustum} + {V}_{right hexagon}$$

$${V}_{cell} = \{ \frac{h}{3} ( {A}_{cell} + {A}_{base} + \sqrt{{A}_{cell} \times {A}_{base}} ) \} + {A}_{cell} \times {T}_{glass}$$

$${V}_{cell} = \{ \frac{8 mm}{3} ( 54.5 {mm}^{2} + 36.3 {mm}^{2} + 44.5 {mm}^{2} ) \} + {A}_{cell} \times {T}_{glass}$$

$${V}_{cell} = \{ \frac{8 mm}{3} ( 54.5 {mm}^{2} + 36.3 {mm}^{2} + 44.5 {mm}^{2} ) \} + 54.5 {mm}^{2} \times 2 mm$$

$${V}_{cell} = 360.7 {mm}^{3} + 109 {mm}^{3} = 469.7 {mm}^{3}$$

The contained ratio is therefore

$$\frac{{V}_{well}}{{V}_{cell}} = 57 \%$$

To calculate the ratio of the contained volume of the wells to the total occupied volume of the repressed glass sheet, it is only necessary to compare the occupied volume of a single cell, V_{cell}, with the volume of an individual well, V_{well}. In the example, the individual wells are arranged in a space-filling tiled array. In the example, V_{well} can be computed as the volume of a frustum given by (h/3)(A₁+A₂+sqrt(A₁×A₂)) where h is the height of the frustum and A₁ and A₂ are the areas of the parallel ends. In the example, A₁ and A₂ are 41.57 and 25.93 mm², respectively and h is 8 mm. The walls may slope in at an angle of 84°. This leads to a well volume, V_{well}, of 267.6 mm³. The total volume of the well plus glass walls, V_{cell} is approximated by the volume of the glass frustum plus the volume of a right hexagonal plate with a height equal to the glass thickness. In the example, the frustum volume is defined by a hexagon located in the middle of the cell wall having an area A₁ of 54.5 mm² and a second hexagon defined by the glass surface at the top of the frustum with an area A₂ of 36.3 mm². The right hexagonal plate is just A₁×T_{glass} where T_{glass} is the glass thickness or 2 mm in this example. Using the previous formula for the of a frustum, this leads to a total cell volume, V_{cell}=360.7 mm³+109 mm³=470 mm³. Comparing this to the volume of the well, we have V_{well}/V_{cell}=57%. It will be appreciated that reducing the thickness of the glass T_{glass} and reducing the thickness of the glass between the wells will lead to higher values of this ratio. For example, reducing the glass thickness to 0.7 mm would increase the contained volume ratio to 67%. On the other hand, increasing the distance between cells to 2 mm would reduce the contained volume ratio to 44%.

Advantages of the embodiments include compositional flexibility. For example, the method of repressing a sheet into a multi-well structure can use high temperature glasses such as alkali-free alkaline earth borosilicates (EAGLE™ or JADE™) that do not lend themselves to conventional molten glass forming. Lower temperature glasses such as PYREX™ GORILLA™, and soda lime are also possible to repress from sheet according to the embodiments herein.

Further, repressing according to the embodiments can provide high fidelity of the repressed structure to the mold. For example, the repressed structure can have complex surface features, such as, in addition to wells, other features such as alignment structures, dicing notches and the like. In the embodiments, the process can be scaled-up to include large sheets, for example, 400 mm×500 mm, and multiple mold/sheet units can be stacked in a single pressing operation.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A multi-well glass-containing structure, comprising:
at least one well,
wherein the at least one well is defined by a top rim, at least one wall, and a well bottom,
wherein the top rim is at a top of a plate to define a well opening, the well bottom is at a bottom of the plate, and the at least one wall extends from the top rim to the well bottom,
wherein a well aspect ratio, AR, of the depth of the at least one well, d_{w}, to a maximum surface dimension of the well opening, Dₘₐₓ, AR=d_{w}/Dₘₐₓ×100%, is in a range from 40% to 100%, and
wherein an inner surface of the at least one well has an average roughness measured by profilometer ZYGO™ New View 7300™ instrument, Ra, of Ra<600 nm.

2. The structure of claim 1, wherein an inner surface of the at least one well has a Ra<250 nm.

3. The structure of claim 1, wherein an inner surface of the at least one well has a Ra<60 nm.

4. The structure of claim 1, wherein the at least one wall comprises a thickness between about 50 microns and 500 microns.

5. The structure of claim 1, wherein the at least one well comprises a shape in the form of any of a circular frustum, an oval frustum, an asymmetrical frustum, a symmetrical frustum, a triangular frustum, a rectangular frustum, a hexagonal frustum, another polygonal frustum, or a combination thereof.

6. The structure of claim 1, wherein the at least one well comprises a plurality of wells, and wherein adjacent walls of adjacent wells are spaced apart from each other by a gap of at least one wall thickness distance.

7. The structure of claim 1, wherein the at least one well comprises a plurality of wells, and wherein an open surface area of the top of the plate, defined as the well opening area divided by a well occupied area of the well plate, is in a range from about 60% to about 85%.

8. The structure of claim 1, wherein the at least one well comprises a contained volume in a range from about 40% to about 70%, wherein the contained volume is defined as the volume of the at least one well divided by the sum of the volume of the glass element and the volume of the at least one well.

9. The structure of claim 1, wherein the inlet end further comprises a flat top surface having a Ra<600 nm.

10. The structure of claim 9, further comprising:
a cover glass hermetically sealed to the top surface.

11. The structure of claim 1, further comprising a first main surface comprising the top of the plate and the inner surface of the at least one well; and a second main surface opposed to the first main surface, wherein at least one of the first main surface and second main surface is ion strengthened.

12. A system to manufacture a glass-containing multi-well structure, the system comprising:
a mold comprising at least one surface cavity and a coefficient of thermal expansion that substantially matches a coefficient of thermal expansion of a glass-containing sheet to be disposed on a surface comprising the surface cavity;
a furnace configured to heat the mold having the glass-containing sheet disposed thereon to a forming temperature corresponding to a viscosity of about 10⁵ poises to about 10^{7,6} poises of the glass-containing sheet; and
a pressing element configured to press the glass-containing sheet at the forming temperature to conform to the at least one surface cavity,
wherein the at least one surface cavity is configured to form the glass-containing sheet into at least one well, the at least one well having a well aspect ratio, AR of the depth of the at least one well, d_{w}, to a maximum surface dimension of an open area of the at least one well Dₘₐₓ, AR=d_{w}/Dₘₐₓ×100% in a range from 40% to 100%, and an inner surface of the at least one well having an average roughness measured by profilometer ZYGO™ New View 7300™ instrument, Ra, of Ra<600 nm.

13. A method of manufacturing a multi-well structure, the method comprising:
disposing a sheet comprised substantially of glass on a mold comprising at least one surface cavity, wherein the mold has a first coefficient of thermal expansion and the sheet has a second coefficient of thermal expansion substantially the same as the first coefficient of thermal expansion;
heating isothermally the mold and the sheet to a predetermined temperature, wherein the predetermined temperature corresponds to a viscosity of about 10⁵ poises to about 10^{7,6} poises of the sheet;
applying molding pressure to the sheet to force the sheet to conform to the at least one surface cavity;
holding the sheet disposed on the mold under the applied pressure for about 10 to 60 minutes;
cooling the sheet disposed on the mold; and
removing the sheet from the mold, wherein the sheet comprises at least one well corresponding to the at least one surface cavity,
wherein the well has a well aspect ratio, AR of the depth of the at least one well, d_{w}, to a maximum surface dimension of an open area of the at least one well Dₘₐₓ, AR=d_{w}/Dₘₐₓ×100% is in a range from 40% to 100%, and
wherein the inner surface of the at least one well has an average roughness measured by profilometer ZYGO™ New View 7300™ instrument, Ra, of Ra<600 nm.

14. The method of claim 13, wherein the applying molding pressure to the sheet comprises disposing a mating mold on the glass sheet having an inverse of the at least one surface cavity, and applying pressure to urge the mold and mating mold together, wherein the at least one surface cavity and inverse of the at least one surface cavity differ by a wall thickness of the at least one well.

15. The method of claim 13, wherein the applying molding pressure to the sheet comprises applying a vacuum between an under surface of the sheet and a surface of the at least one surface cavity to cause the sheet to conform to the at least one surface cavity.

16. The method of claim 13, further comprising prior to disposing the sheet on the mold, polishing the at least one surface feature of the mold to at least 600 mesh or finer.

17. The method of claim 13, wherein the mold comprises graphite or boron nitride.

18. The method of claim 13, wherein the sheet comprises a laminate glass, wherein the laminate glass comprises an outer layer soluble in a solute and an inner layer insoluble in the solute,
wherein after removing the sheet from the mold, the outer layer is dissolved in the solute.

19. The method of claim 13, wherein the first coefficient of thermal expansion is in a range of about 3 ppm/° C. to about 9 ppm/° C.

20. A multi-well glass-containing structure, comprising:
at least one well,
wherein the at least one well is defined by a top rim, at least one wall, and a well bottom,
wherein the top rim is at a top of a corrugated plate to define a well opening, the well bottom is at a bottom of the corrugated plate, and the at least one wall extends from the top rim to the well bottom,
wherein a well aspect ratio, AR, of the depth of the at least one well, d_{w}, to a maximum surface dimension of the well opening, Dₘₐₓ, AR=d_{w}/Dₘₐₓ×100%, is in a range from 40% to 100%, and
wherein an inner surface of the at least one well has an average roughness measured by profilometer ZYGO™ New View 7300™ instrument, Ra, of Ra<600 nm,
wherein the at least one well comprises a plurality of wells disposed in a well occupied area of the corrugated plate, and wherein an open surface area of the top of the corrugated plate, defined as the well opening area divided by the well occupied area of the well plate, is in a range from about 60% to about 85%.
